(19) United States
(12) Patent Application Publication
(10) Pub. No.: US 2002/0174316 A1
(43) Pub. Date: Nov. 21, 2002

(54) Dynamic resource management and allocation in a distributed processing device

(75) Inventors: Michele Zampetti Dale, Quakertown, PA (US); Ryan Scott Holmqvist, Basking Ridge, NJ (US); Farrukh Amjad Latif, Lansdale, PA (US)

Correspondence Address: HITT GAINES & BOISBRUN P.C., P.O. BOX 832570, RICHARDSON, TX, 75083, US

(73) Assignee: TelGen Corporation, Lansing, MI (US)

(21) Appl. No.: 09/861,384

(22) Filed: May 18, 2001

(51) Int. Cl. G06F 13/00

(52) U.S. Cl. 711/170

(57) ABSTRACT

A processing device contains a global free queue, containing a list of pointers linked to memory indicating free space in memory for which to store the data prior to its transmission. A plurality of functional blocks used to process the data in a distributed system, are configured to receive data from a physical interface and store such data in memory once it is received. Each of the plurality of functional blocks allocate a portion of the pointers from said list from which to store the data once the data is received from said physical interface. Each of the plurality of functional blocks are able store data autonomously and directly into memory in a location based on the pointers, immediately after data is received from the physical interface.

### TECHNICAL FIELD OF THE INVENTION

The present invention is directed, in general, to management of resources in a distributed processing device, and, more specifically, to dynamic allocation of resources in a communication processing device.

### BACKGROUND OF THE INVENTION

Communication devices, such as gateways and integrated access devices, often have to handle a large of influx of communications data in various protocol formats at unpredictable intervals. When such data “shows up” on wire interfaces of the these communication devices, a decision of what to do with the data must be performed quite quickly, in “real-time” (in the order of nano-seconds), otherwise quality of service will suffer; i.e., interactive communications data, such as, voice or video, may reach its destination jittery, garbled and/or unintelligible.

One dilemma facing the industry is how to more efficiently process data, after it shows-up on the wire interface. Most gateway devices, receive data, process the data, and then transmit/route it to its destination in a protocol format compatible with the destination of the data. Efficiency often depends on the number of times the data needs to be stored in memory (whether local, main and/or both) as it is processed by the device.

When data shows up on the physical interface of the communication device (i.e., via a wire), many conventional devices typically buffer the data or place it in local memory prior to a central processor processing the data. Real-time data, such as voice communication or video, arrives on the wire at very high rates. It is typically necessary to temporarily store such data, because the central processor of the communication device is typically tasked with processing data it received earlier.

Once the processor is able to retrieve the data from temporary storage, it is normally sent to main memory and assigned an address in memory for retrieval at a later time. Often times, the same data needs to be written into memory (or temporary buffers) several times in order to process it especially in a multi-protocol environment, where control information needs to be segmented and then reassembled. Each time data is read and written in to memory, latency times build-up adding delay from the time data is received until data is finally transmitted by the gateway device.

Sharing of resources are often a subproblem associated with the influx data. Operating systems, memory, input/output devices, are all types of shared resource that must be locked and unlocked each time they are called upon to perform their particular task. When resources are shared, they need to be procured under lock so that a device or function (operating system)procuring it does not corrupt or trash work that another device may be performing using the same resource. For example, when data is sent to memory by a the central processor the operating system may be called upon to perform the write operation. For instance, the operating system processes code and searches for a block of memory to allocate space in memory to store the data. During this time, the processor needs to wait until the operating system completes the allocation. Additionally, the memory and/or the processor may be locked-up until the data is finally stored. Thus, allocating memory space repetitively, as described above, is very time consuming.

Another problem associated with conventional systems occurs when attempting to monitor and adjust allocation of resources. For instance, in a distributed communication system streaming data may quickly overload resources. Typically, the central processor of a system is used to adjust and allocate resources as streaming data is received. Being able to efficiently make resource adjustments in a dynamic fashion is a goal of most communication processing devices.

Accordingly, what is needed in the art is a processing device with the ability to increase throughput and speed by reducing memory reads and writes and any aforementioned subproblems inherent with storing and restoring data in memory. Such a device needs to operate in communications processing environment with the ability to receive and route streaming data including voice, video, and bursty data, concurrently. Such a device also needs to be able to dynamically adjust resources to account for incoming streaming data.

### SUMMARY OF THE INVENTION

To address the above-discussed deficiencies of the prior art, the present invention provides a distributed processing device or method for receiving and transmitting data with minimal memory reads and writes. This is accomplished by the use of a global free queue, containing a list of pointers linked to memory indicating free space to receive data in memory for which to store data prior to its transmission. A plurality of functional blocks, receive data from a physical interface and store the data in memory once it is received. Each of the plurality of functional blocks utilize a portion of the pointers from the list from which to store the data once the data is received from the physical interface. The plurality of functional blocks then assign particular pointers to particular data as it is received from the physical interface. Then store such data in a location in memory indicated by such pointers.

Accordingly, the received data need only be stored in memory one time at an address indicated by the pointers until a time when the data is ready to be read from memory for transmission of the data from the device. There is no need to rely on cumbersome operating systems to allocate memory space for the data, or a need to lock-up memory after memory space has been allocated by the pointers. Furthermore, at no time is the central processor needed to assist in allocating resources in memory for data to be written or read.

The present invention therefore introduces the broad concept of autonomously managing resources without the need for operating systems, central processors or locking mechanisms. The global free queue provides a source for all the functional blocks to request memory resources via pointers for allocation of data. Data payloads can be stored in memory immediately after being received by the functional blocks. Thereafter, such data can remain stored in memory at a location indicated by the pointers, while the functional blocks process control information associated with data stored in memory. So, the functional blocks do not need to move the actual data payload each time control information corresponding to the data is moved and processed between functional blocks in the communications device. The pointers, act as a means to link the control information associated with data payload in memory.

In one embodiment of the present invention, at least one of the functional blocks contains a low water mark indicator configured to prompt the functional block to allocate more pointers from the global free queue to the functional block when the functional block is running out of pointers from which to store data in memory.

In another embodiment of the present invention, at least one of said functional blocks contains a high water mark indicator, configured to prompt the functional block to return pointers to the global free queue, when the functional block has more than an adequate supply of pointers allocated from the global free queue from which to store data in memory. Accordingly, the high and low water marks provide a means to dynamically manage shared resources of the communications device.

In a still further embodiment of the present invention, at least one of the functional blocks has the ability to recycle pointers for assignment to new incoming data, after data, previously associated with such recycled pointers, is sent by said functional block for transmission over the physical interface. Thus, it is not necessary to send the freed pointers back to the global queue, which may be a time consuming operation. By recycling freed pointer instead of sending them back to the global free queue, delays are avoided. Such delays include, but are not limited to atomic operation locks associated with a shared queue and messaging handshaking operations.

In still a further embodiment of the present invention, the global free queue contains a list of transaction state entry pointers each of the transaction state entry pointers pointing to a location in memory for storage of a packet. Transaction state entries is a hierarchy of a collection of buffers that forms a meaningful data block for a given protocol.

In another embodiment of the present invention, the global free queue contains a list of buffer state entry pointers where each of the buffer state entry pointers pointing to a location in memory for storage of a portion of a packet of data. Buffer state entries are a much smaller units or blocks of data than TSEs and are used to hold actual data. Management (allocation and reuse or reclamation) of TSEs and BSEs is resource management.

In another embodiment of the present invention, a multiple chip embodiment is shown employing the concepts of the present invention.

One advantage of the present invention is the ability to distribute resources in a distributed communication processing environment.

Another advantage of the present invention is the optional elimination of a central processor handling memory resource processes. So, other functional processing devices, receiving data may directly and autonomously synchronize with main memory and reduce read and writes. In fact, it is only necessary to store data once, using the concepts described by the present invention.

Still another advantage of the present invention is a self correcting resource process. If any of the functional blocks are becoming low on allocated resources, they can request more from the global free queue. On the other hand, if any of the functional blocks have too many allocated resources (e.g., a “hog”) then they can send them back to the global free queue where such freed pointers are enqueued and can be re-used by another functional block that may need more resources.

A further advantage of the present invention, is the ability to reduce the amount of traffic associated with processing and monitoring resources of a system as real-time data is flowing in and out of the communication device.

A still further advantage of the present invention, is the elimination of a blocked (e.g., locked) structure, when attempting to request allocated resources from memory. So that there is no delay when requesting shared resources.

The foregoing has outlined, rather broadly, preferred and alternative features of the present invention so that those skilled in the art may better understand the detailed description of the invention that follows. Additional features and advantages of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 shows a multi-protocol environment that a communication device may be employed, in accordance with one embodiment of the present invention;

FIG. 2 is a block diagram of a communication device according to a an illustrative embodiment of the present invention;

FIG. 3 is a block diagram of sample hardware used in an Intelligent Protocol Engine in accordance with an illustrative embodiment of the present invention;

FIG. 4 is an isolated block diagram of an illustrative management resource system employed in a communication processing device according to an embodiment of the present invention;

FIG. 5 is a flow diagram showing the general operation of a resource management system according to an illustrative embodiment; and

FIG. 6 is a block diagram of a multi-chip communication processing system with more than one memory, according to an illustrative embodiment of the present invention.

### DETAILED DESCRIPTION

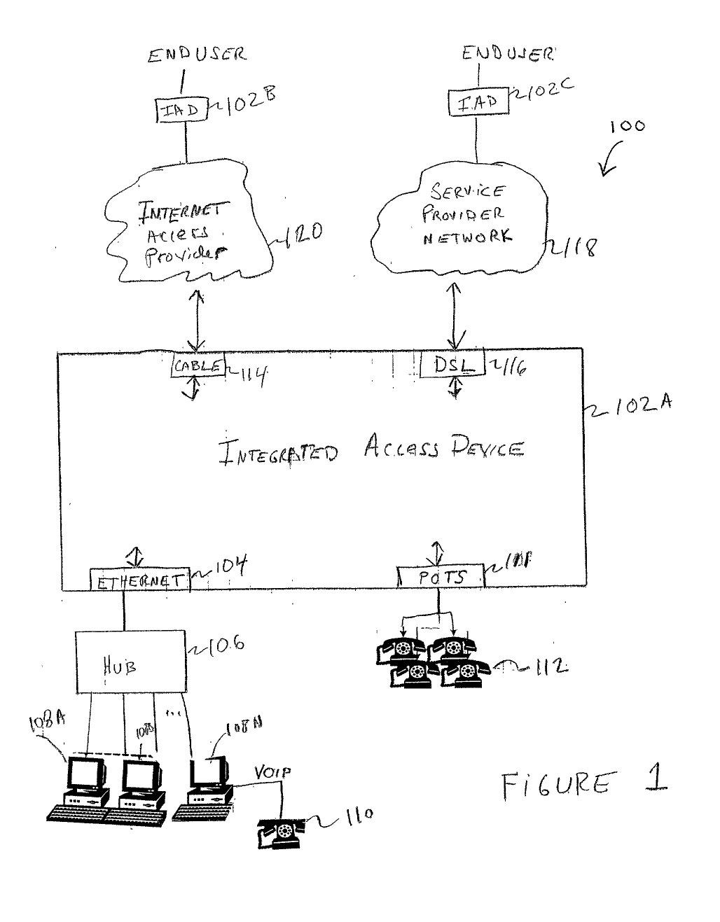

FIG. 1 shows a multi-protocol environment 100 where a communication device 102 may be employed, in accordance with one embodiment of the present invention. In this example, communication device 102 is an integrated access device (IAD) that bridges two networks. That is, IAD 102 concurrently supports voice, video and data and provides a gateway between other communication devices, such as individual computers 108, computer networks (in this example in the form of a hub 106) and/or telephones 112 and networks 118, 120. In this example, IAD 102A supports data transfer between an end user customer's site (e.g., hub 106 and telephony 112) and Internet access providers 120 or service providers' networks 118 (such as Sprint Corp., AT&T and other service providers). More specifically, IAD 102 is a customer premise equipment device supporting access to a network service provider.

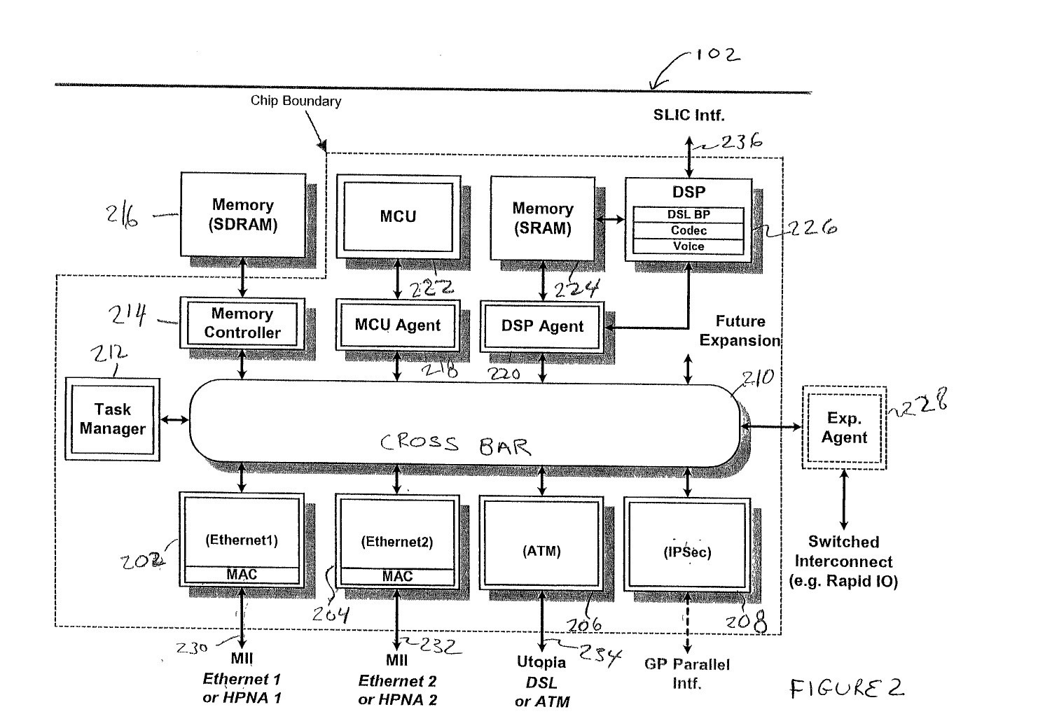

FIG. 2 is a block diagram of device 102 according to an illustrative embodiment of the present invention. Device 102 is preferably implemented on a single integrated chip to reduce cost, power and improve reliability. Device 102 includes intelligent protocol engines (IPEs) 202-208, a cross bar 210, a function allocator (also referred to as a task manager module (TMM)) 212, a memory controller 214, a Micro Control Unit (MCU) agent 218, a digital signal processor agent 220, a MCU 222, memory 224 and a DSP 226.

External memory 216 is connected to device 102. External memory 216 is in the form of synchronized dynamic random access memory (SDRAM), but may employ any memory technology capable of use with real-time applications. Whereas, internal memory 224 is preferably in the form of static random access memory, but again any memory with fast access time may be employed. Generally, external memory 216 is unified (i.e., MCU code resides in memory 216 that is also used for data transfer) for cost sensitive applications, but local memory may be distributed throughout device 102 for performance sensitive applications such as internal memory 224. Local memory may also be provided inside functional blocks 202-208, which shall be described in more detail below.

Also shown in FIG. 2, is an expansion port agent 228 to connect multiple devices 102 in parallel to support larger hubs. For example, in a preferred embodiment, device 102 supports 4 POTS, but can easily be expanded to handle any number of POTS such as a hub. Intelligent protocol engines 202-208, task manager 212 and other real-time communication elements such as DSP 226 may also be interchangeably referred to throughout this description as “functional blocks.” Other functional processing elements, such as standard processors, may be substituted for IPEs 202 without departing from the overall spirit of the present invention. Thus, functional blocks may include, but is not limited to, off-the-shelve processors, DSPs, and related functional processing devices.

Data enters and exits device 102 via lines 230-236 to ingress/egress ports in the form of IPEs 202-206 and DSP 226. For example voice data is transmitted via a subscriber line interface circuit (SLIC) line 236, most likely located at or near a customer premise site. Ethernet type data, such as video, non-real-time computer data, and voice over IP, are transmitted from data devices (shown in FIG. 1 as computers 108) via lines 230 and 232. Data sent according to asynchronous transfer mode (ATM), over a digital subscriber line (DSL), flow to and from service provider's networks or the Internet via port 234 to device 102. Although not shown, device 102 could also support ingress/egress to a cable line (not shown) or any other interface.

The general operation of device 102 will be briefly described. Referring to FIG. 2, device 102 provides end-protocol gateway services by performing initial and final protocol conversion to and from end-user customers. Device 102 also routes data traffic between an Internet access/service provider network 118, 120, shown in FIG. 1. Referring back to FIG. 2, MCU 222 handles most call and configuration management and network administration aspects of device 102. MCU 222 also may perform very low priority and non-real-time data transfer (e.g., control type data) for device 102, which shall be described in more detail below. DSP 226 performs voice processing algorithms and interfaces to external voice interface devices (not shown) . IPEs 202-208 perform tasks associated with specific protocol environments appurtenant to the type of data supported by device 102 as well as upper level functions associated with such environments. TMM 212 manages flow of control information by enforcing ownership rules between various functionalities performed by IPEs 202-208, MCU 222 or DSP 226.

With high and low level watermarks (described in more detail below and with reference to FIG. 7), TMM 212 is able to notify MCU 222 if any IPE 202-208 is over or under utilized. Accordingly, TMM 212 is able to ensure dynamic balancing of tasks performed by each IPE relative to the other IPEs.

Most data payloads are placed in memory 216 until IPE's complete their assigned tasks associated with such data payload and the payload is ready to exit the device via lines 230-236. The data payload need only be stored once from the time it is received until its destination is determined. Likewise time critical realtime data payloads can be placed in local memory or buffer (not shown in FIG. 2) within a particular IPE for immediate egress/ingress to a destination or in memory 224 of the DSP 226, bypassing external memory 216. Most voice payloads are stored in internal memory 224 until IPEs 202-208 or DSP 226 process control overhead associated with protocol and voice processing respectively.

A cross bar 210 permits all elements to transfer data at the rate of one data unit per clock cycle without bus arbitration further increasing the speed of device 102. Cross bar 210 is a switching fabric allowing point-to-point connection of all devices connected to it. Cross bar 210 also provides concurrent data transfer between pairs of devices. In a preferred embodiment, the switch fabric is a single stage (stand-alone) switch system, however, a multi-stage switch system could also be employed as a network of interconnected single-stage switch blocks. A bus structure or multiple bus structures (not shown) could also be substituted for cross bar 210, but for most real-time applications a crossbar is preferred for its speed in forwarding traffic between ingress and egress ports (e.g., 202-208, 236) of device 102. Device 102 will now be described in more detail.

MCU 222 is connected to an MCU agent 218 that serves as an adapter for coupling MCU 222 to cross bar 210. Agent 218 makes the cross bar 210 transparent to MCU 222 so it appears to MCU 222 that it is communicating directly with other elements in device 102. As appreciated by those skilled in the art, agent 218 may be implemented with simple logic and firmware tailored to the particular commercial off-the-shelf processor selected for MCU 222.

DSP 226 may be selected from any of the off-shelf manufactures of DSPs or be custom designed. DSP 226 is designed to perform processing of voice and/or video. In the embodiment shown in FIG. 2, DSP 226 is used for voice operations. DSP agent 220 permits access to and from DSP 226 from the other elements of device 102. Like MCU agent 218, DSP agent 220 is configured to interface with the specific commercial DSP 226 selected. Those skilled in the art appreciate that agent 220 is easily designed and requires minimal switching logic to enable an interface with cross bar 210.

TMM 212 acts as a function coordinator and allocator for device 102. That is, TMM 212 tracks flow of control in device 102 and associated ownership to tasks assigned to portions of data as data progresses from one device (e.g., 202) to another device (e.g., 226).

Additionally, TMM 212 is responsible for supporting coordination of functions to be performed by devices connected to cross bar 210. TMM 212 employs queues to hand-off processing information from one device to another. So when a functional block (e.g., 202-208 & 222) needs to send information to a destination outside of it (i.e., a different functional block) it requests coordination of that information through TMM 212. TMM 212 then notifies the device, e.g., IPE 202 that a task is ready to be serviced and that IPE 202 should perform the associated function. When IPE 202 receives a notification, it downloads information associated with such tasks for processing and TMM 212 queues more information for IPE 202. As mentioned above, TMM 212 also controls the logical ownership of protocol specific information associated with data payloads, since device 102 uses shared memory. In essence this control enables TMM 212 to perform a semaphore function.

It is envisioned that more than one TMM 212 can be employed in a hub consisting of several devices 102 depending on the communication processing demand of the application. In another embodiment, as mentioned above, a high and low water mark in TMM 212 can be used to ascertain whether any one functional block is over or under-utilized. In the event either situation occurs, TMM 212 may notify MCU 222 to reconfigure IPEs 202-208 to redistribute the functional workload in more balanced fashion. In a preferred embodiment, the core hardware structure of a TMM 212 is the same as IPEs 202-208, described in more detail as follows.

IPEs 202-208 are essentially scaled-down area-efficient micro-controllers specifically designed for protocol handling and real-time data transfer speeds. IPEs 202 and 204 are assigned to provide ingress/egress ports for data associated with an Ethernet protocol environment. IPE 206 serves as an ingress/egress port for data associated with an ATM protocol environment. IPE 208 performs a collection of IP security measures such as authentication of headers used to verify the validity of originating addresses in headers of every packet of a packet stream. Additional, IPEs may be added to device 102 for added robustness or additional protocol environments, such as cable. The advantage of IPEs 202-208 is that they are inexpensive and use programmable state machines, which can be reconfigured for certain applications.

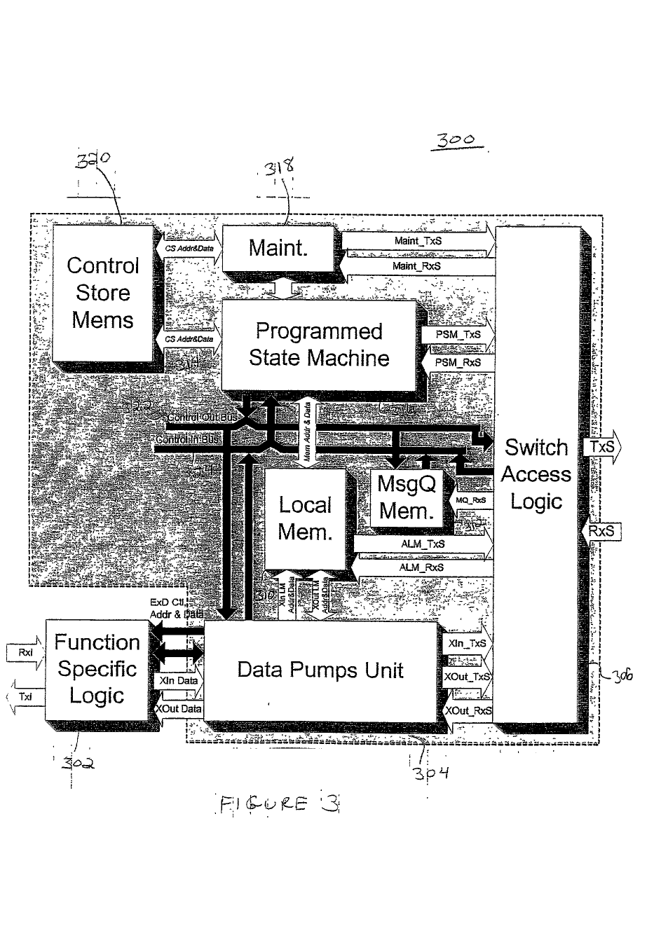

FIG. 3 is a block diagram of sample hardware used in an IPE 300 in accordance with a preferred embodiment of the present invention. Other than interface specific hardware, it is generally preferred that the hardware of IPEs remain uniform. IPE 300 includes: an interface specific logic 302, a data pump unit 304, switch access logic 306, local memory 310, a message queue memory 312, a programmed state machine 316, a maintenance block 320, and control in and out busses 322, 324. Each element of IPE 300 will be described in more detail with reference to FIG. 3. Programmed state machine 316 is essentially the brain of an IPE. It is a micro-programmed processor. IPE 300 may be configured with instruction words that employ separate fields to enable multiple operations to occur in parallel. As a result, programmed state machine 316 is able to perform more operations than traditional assembly level machines that perform only one operation at a time. Instructions are stored in control store memory 320. Programmed state machine 316 includes an arithmetic logic unit (not shown, but well known to those skilled in the art) capable of shifting and bit manipulation in addition to arithmetic operations. Programmed state machine 316 controls most of the operations throughout IPE 300 through register and flip-flop states (not shown) in IPE via Control In and Out Busses 322, 324. Busses 322, 324 in a preferred embodiment are 32 bits wide and can be utilized concurrently. It is envisioned that busses 322, 324, be any bit size necessary to accommodate the protocol environment or function to be performed in device 102. It is envisioned, however, that any specific control or bus size implementation could be different and should not be limited to the aforementioned example.

Switch access logic 306 contains state machines necessary for performing transmit and receive operations to other elements in device 102. Switch access logic 306 also contains arbitration logic that determines which requester within IPE 300 (such as programmed state machine 316 or data pump unit 304) obtains a next transmit access to cross bar 210 as well as routing required information received from cross bar 210 to appropriate elements in IPE 300.

Maintenance block 318 is used to download firmware code that is downloaded during initialization or re-configuration of IPE 300. Such firmware code is used to program the programmed state machine 316 or debug a problem in IPE 300. Maintenance block 318 should preferably contain a command queue (not shown) and decoding logic (not shown) that allow it to perform low level maintenance operation to IPE 300. In one implementation, maintenance block 318 should also be able to function without firmware because its primary responsibility is to perform firmware download operations to control store memory 320.

In terms of memory, control store memory is primarily used to supply programmed state machine 316 with instructions. Message queue memory 312 receives asynchronous messages sent by other elements for consumption by programmed state machine 316. Local memory 310 contains parameters and temporary storage used by programmed state machine 316. Local memory 310 also provides storage for certain information (such as headers, local data and pointers to memory) for transmission by data pump unit 304.

Data pump unit 304 contains a hardware path for all data transferred to and from external interfaces. Data pump unit 304 contains separate ‘transfer out’ (Xout) and ‘transfer in’ (Xin) data pumps that operate independently from each other as a full duplex. Data pump unit 304 also contains control logic for moving data. Such control is programmed into data pump unit 304 by programmed state machine 316 so that data pump unit 304 can operate autonomously so long as programmed state machine 316 supplies data pump unit 304 with appropriate information, such as memory addresses.

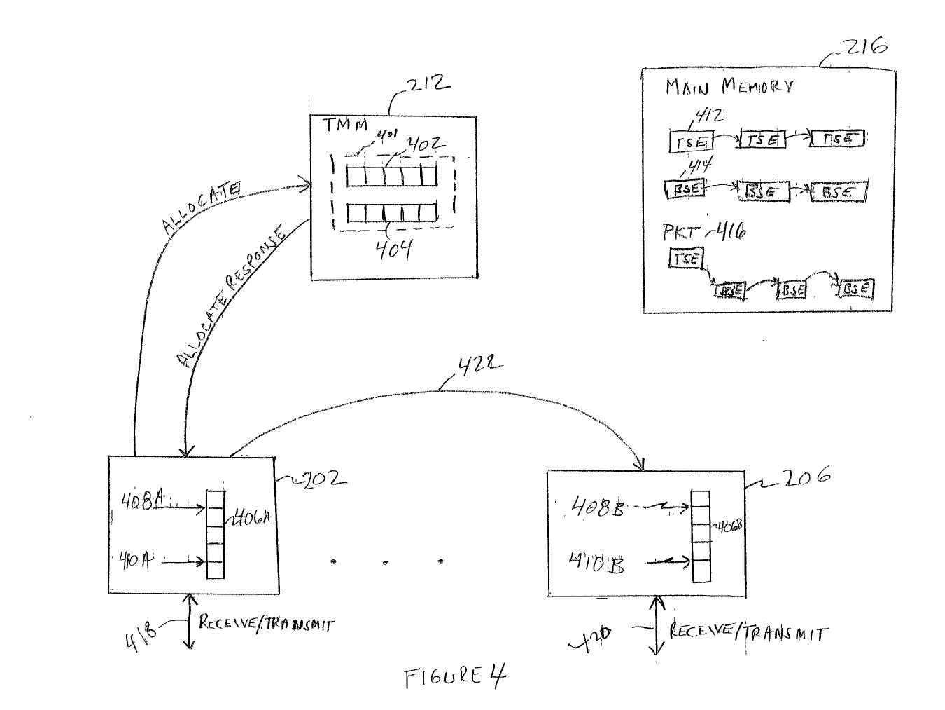

FIG. 4 is an isolated block diagram of an illustrative management resource system 400 employed in device 102 according to an illustrative embodiment of the present invention. System 400 includes: TMM 212, functional blocks 202,206 and main memory 216. As will also become apparent after reading further, system 400 cuts down on message trafficking and is autonomous. System 400 generally eliminates the need for a host processor, such as MCU 222 shown in FIG. 2, to be engaged in resource allocation and management.

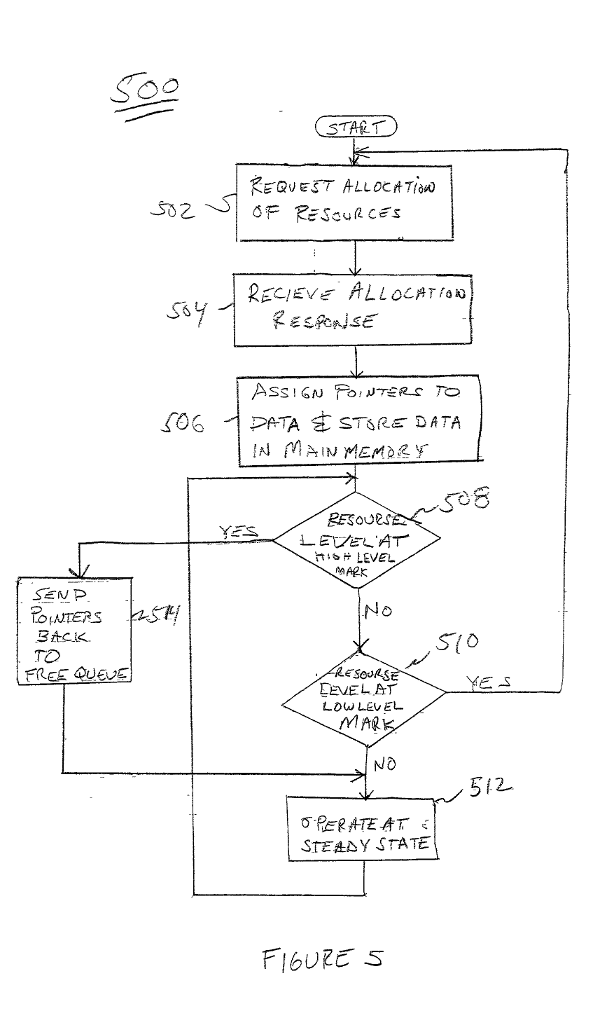

The operation of system 400 will now be generally described with reference to FIGS. 4 and 5, wherein FIG. 5 is a flow diagram showing the general operation of system 400 according to an illustrative embodiment.

Referring to FIGS. 4 and 5, in step 502 one or more of functional blocks (e.g., IPEs 202-206) request allocation of resources from memory. In other words, IPEs 202 and 206 are able to request pointers that are linked to locations in memory 216. So, IPEs request a list of pointers from (e.g., Transaction State Entries (TSEs pointers), queue 402, and Buffer State Entries (BSEs) from queue 404. Each TSE represents, in essence represents a collection of buffer state entries (or buffers) that forms a meaningful data block for a given protocol. In this embodiment each TSE represents a 1000 byte packet. Each BSE is made up of smaller portions of a single TSE or in this embodiment 64 bytes. As shown in memory 216, each TSE 412 points to a next TSE 412, and likewise each BSE 414 points to another BSE, but a packet 416 is represented by a TSE made-up of several BSEs. A pointer is in essence a tag that represents an address location in memory 216.

It should be noted that TSEs and BSEs could be reduced to a single entry location of various sizes or other more elaborate representations equivalent to TSEs/BSEs with varying data sizes depending on the application. Consequently, global free queues 401 may consist of one, two or many queues depending on the application and the number of different resources employed. In this embodiment, it is generally preferred to use two separate queues 402, 404 with separate resource types, TSEs and BSEs pointers, that are not intermixed to avoid ordering issues and reducing searching problems.

At this point in step 502, pointers associated to TSEs 412 and BSEs 414 in memory 216 generally refer to locations that are free of data. IPEs 202, 206 do not have to wait for a response from global queue 401 and may continue to execute assuming that pre-allocation of resources in memory was made during initialization start-up of device 102.

In step 504, IPEs 202, 206 receive an allocation response (a message about global free queue) from TMM 212 (via global free queues 401). Even if the response comes at an inconvenient time for an IPE, it may be stored in a local queue 406 within an IPE 202 or 206 for access at a more convenient time. By having a reflexive functional system, functional blocks (such as IPEs 202, 206) do not need to remember a request has been made,and can pick-up pointers from their internal queues 406 at a convenient time for each of them.

In step 504, each IPE 202, 206 receives data from a physical interface such as a wire 418, 420. Data received from a physical interface 418, 420 generally needs to be stored in memory 216 until it can be processed and transmitted to such data's destination. Referring to FIG. 4, in this example it is assumed that IPE 202 will eventually need to send the data it received to IPE 206 for transmission via wire 420. A representative arrow 422 shows a transfer of data from IPE 202 to IPE 206.

In reality, a data payload enters IPE 202 and is stored in memory 216 at a location allocated by freed pointers received from global free queue 401. So, in step 506, IPE actually assigns TSE and BSE pointers to a portion of data received over wire 418 and immediately stores the data in a free location in memory linked to such pointers.

At this point, IPE 202 can process control information associated with the data stored in memory. For instance, IPE 202 may strip information and begin formatting the data in a protocol format compatible for eventual transmission by IPE 206. Instead of sending the actual data payload to IPE 206 via representative arrow 422, the pointers assigned to the particular data can be sent to IPE 206. This way, control information associated with the pointers can be manipulated and processed without having to store and restore massive amounts of data payloads. Additionally, stripped control information associated with the data payload, (e.g., a header) can be attached to the pointers and passed to various functional blocks without having to physically move the data. So, the pointers not only facilitate a place to store data in memory 216, they also provide a mechanism to track data payloads passed from one processing element to another in a distributed system, such as device 102.

Once the data received over a physical wire 418,420 is stored in memory 216 at locations indicated by pointers stored from local queues 406A,B, each IPE 202, 206 monitors its resource level. indicator 408A,B. If in decisional step 508, the high water indicator 408A,B is beyond its assigned limit, it means that the particular IPE 202, 206 needs to free some resources to other devices that may need them. In other words, according to the “YES” branch of step 508, an IPE is going to send pointers back to global free queue 401 for potential reallocation to other functional blocks that may be running out of memory resources for which to store data. In this way, each functional block is able to autonomously monitor its resource level and dynamically allocate resources to devices that may need them.

Each functional block, such as IPE 202,206, also checks whether it is running out of pointers, and therefore, resources to store data it is receiving over the physical interface. Thus, according to a decisional block 510, if resource levels are below an assigned resource allocation indicator level 410A,410B, then IPE 202, 206, according to the “YES” branch of decisional block 510, requests more resources, by asking for TMM 212 to dequeue more pointers from the global queue 401.

Generally, it is desired to set the high and low level water marks at levels that allow each functional block some leeway so that they do not run out of resources to store incoming data; or hog resources so that other functional blocks are unable to receive free allocation pointers from queue 401. The high and low level water mark indicators can be modified, if it appears that any of the functional blocks are either chronically too low on resources or have too many resources. This could be performed off-line by reprogramming the functional blocks (either in firmware or software) depending on the device or handled by a main processor if it receives a signal that one or more of the IPE's water level indicators needs to be changed.

In another aspect of the present invention, any of the functional blocks could “recycle” pointers that are freed-up of data stored in memory (i.e., no data exists in the particular memory location). Recycling could occur after a functional block has transmitted a data payload. The pointer associated with data payload could immediately be re-used to store new incoming data received over the physical interface wire 418,420. Recycling allows each functional device to re-use pointers and avoids having to send pointers back the free queue 401, which can be time consuming and increases message trafficking. This way allocation can occur on an as needed basis when the devices are running low on resources. Also data received over the wire(s) 418,420 can be immediately stored in a location in memory previously assigned to data that was recently transmitted by one of the functional blocks.

Recycling could also be performed in accordance with a water level indicator. For instance, a middle water mark level may indicate that the device is running at a desired optimal level and recycling should occur.

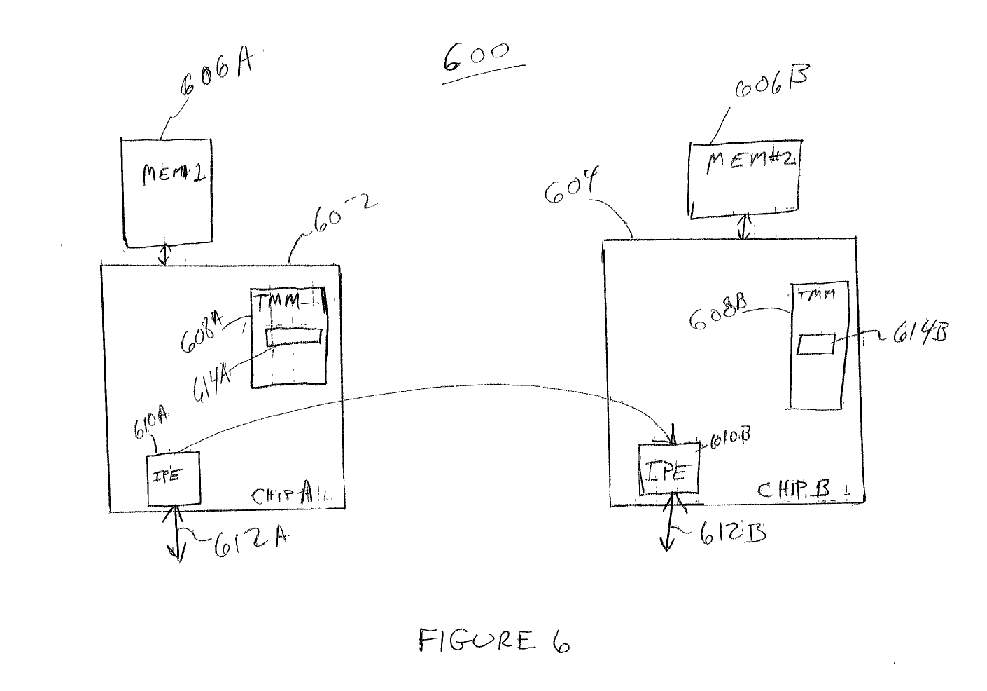

FIG. 6 is a block diagram of a multi-chip communication processing system 600 with more than one memory, according to an illustrative embodiment of the present invention. In this example, system 600 contains two chips 602,604 each having their own memory 606A, 606B, TMMs 608A,B and functional blocks (e.g., IPE 610A 610B), respectively. When data enters IPE 610A via wire 612A, IPE 610A is going to allocate pointers from a free list 614A for assignment to the data of free resources in memory 606A. So a packet of TSEs and BSE may be formed and stored in chip 602's memory 606A.

Much of data communications involves adding/removing headers and trailers to and from packets. IPE 610B may add a header and trailer to the packet. Now, the question arises, how to handle pointers involving multiple chip resources. For example, what happens after IPE 610B transmits data originally received from IPE 610A. What does IPE 606B do with pointers from a different chip?

Communication resources should be localized to a particular chip, so that time is spent traversing multiple chips to off-chip memory for data in minimized. If IPE 610B frees resources to TMM 614B, there is a risk that TMM 614B will contain resources from another chip (e.g. 602). In accordance with one embodiment, therefore, associated with each TSE and BSE is an owner ID word indicating which TMM is controlling it. For example, the owner IDs of trailer and headers added by IPE 610B to a packet sent from IPE 610A is going to refer to TMM 608B. However, the owner ID of the packet (the data payload) is going to refer to chip 602 or TMM 608A.

Once data is freed-up and sent over the wire via 612B, IPE 610B sends all linked lists of pointers associated with the sent data to its own TMM 608B, for re-allocation of freed resources. TMM 614B, in the background, is then responsible for making sure any pointers with owner IDs belonging to TMM 608A are returned to it at TMM 608B's earliest convenience. This can also be performed by sending a message to TMM 608A to free its memory resources that were associated with the assigned pointers, sent by IPE 610B. In essence each TMM 608A,B can be configured with the ability to perform background tasks to return free pointers to their rightful owners.

Although the present invention has been described in detail, those skilled in the art should understand that they can make various changes, substitutions and alterations herein without departing from the spirit and scope of the invention in its broadest form.

What is claimed is:

1. A distributed processing device for receiving and transmitting data, comprising:
a global free queue containing a list of pointers linked to memory indicating free space in memory for which to store said data prior to its transmission; and
a plurality of functional blocks, configured to receive data from a physical interface and store such data in memory once received,
wherein each of said plurality of functional blocks allocate a portion of said pointers from said list from which to store said data once said data is received from said physical interface, thereby permitting said plurality of functional blocks to assign particular pointers to particular data as it is received from said physical interface and then store such data in a location in memory indicated by such pointers.

2. The distributed processing device of claim 1, whereby said received data need only be stored in memory one time at an address indicated by said pointers until a time when said data is ready to be read from memory for transmission of said data.

3. The distributed processing device of claim 1, wherein at least one of said functional blocks contains a low water mark indicator configured to prompt said functional block to allocate more pointers from said global free queue to said functional block when said functional block is running out of pointers from which to store data in memory.

4. The distributed processing device of claim 1, wherein at least one of said functional blocks contains a high water mark indicator, configured to prompt said functional block to return pointers to said global free queue, when said functional block has more than an adequate supply of pointers allocated from said global free queue from which to store data in memory.

5. The distributed processing device of claim 1, wherein at least one of said functional blocks recycles pointers for assignment to new incoming data, after data, previously associated with such recycled pointers, is sent by said functional block for transmission over said physical interface.

6. The distributed processing device of claim 1, wherein said global free queue contains a list of transaction state entry pointers each of said transaction state entry pointers pointing to a location in memory for storage of a packet.

7. The distributed processing device of claim 1, wherein said global free queue contains a list of buffer state entry pointers each of said buffer state entry pointers pointing to a location in memory for storage of a portion of a packet of data.

8. A method for dynamically managing resources in a distributed processing device, said distributed processing device containing multiple functional blocks for processing data, comprising:
transferring N number of pointers from a resource queue to a one of said functional blocks, wherein each of said pointers point to a location in memory for storage of data;
assigning a portion of said N number of pointers to said data as said data is received by said one of said functional blocks; and
storing said data in memory at locations indicated by a said portion of said N number of pointers; and
requesting additional pointers from said resource queue if said portion of said N number of pointers assigned to data received by said functional block is approaching said N number.

9. The method of claim 8, further comprising:
sending J number of pointers to said resource queue, when at least one of said functional blocks has more than an adequate supply of pointers to assign to incoming data received by said functional block, wherein J is less than N.

10. The method of claim 8, further comprising: sending pointers back to said resource queue, once data with assigned pointers is transmitted by said functional block to a device external to said processing device.

11. The method of claim 8, further comprising: recycling a portion of said pointers by reassigning them to incoming data after said pointers refer to data that has been transmitted by at least one said functional block to a device external to said processing device.

12. The method of claim 8, further comprising: sending data directly to memory at a location assigned to said data by a portion of said pointers.

13. The method of claim 8, further comprising: leaving said data in memory after assignment of pointers is completed, until said data is ready for transmittal by one of said functional blocks to a device external to said processing device.

14. A communication system for receiving and transmitting data, comprising:
a global free queue, containing a list of pointers linked to memory indicating free space in memory for which to store said data prior to its transmission; and
a plurality of functional blocks, configured to receive data from a physical interface and store such data in memory once received,
wherein each of said plurality of functional blocks allocate a portion of said pointers from said list from which to store said data once said data is received from said physical interface,
wherein said each of said plurality of functional blocks is able store data autonomously and directly into memory in a location based on said pointers immediately after data is received from said physical interface.

15. The communication system of claim 14, wherein said functional blocks use said pointers as means to transfer control information associated with said data payloads stored in memory without actually having to physically transfer said data payload either in and out of memory.

16. The communication system of claim 14, whereby said received data need only be stored in memory one time at an address indicated by said pointers until a time said data is ready to be read from memory for transmission of said data.

17. The communication system of claim 14, wherein at least one of said functional blocks contains a low water mark indicator configured to prompt said functional block to allocate more pointers from said global free queue to said functional block when said functional block is running out of pointers from which to store data in memory.

18. The communication system of claim 14, wherein at least one of said functional blocks contains a high water mark indicator, configured to prompt said functional block to return pointers to said global free queue, when said functional block has more than an adequate supply of pointers allocated from said global free queue from which to store data in memory.

19. The communication system of claim 14, wherein at least one of said functional blocks recycles pointers for assignment to new incoming data, after data, previously associated with such recycled pointers, is sent by said functional block for transmission over said physical interface.

20. The communication system of claim 14, wherein said global free queue contains a list of transaction state entry pointers each of said transaction state entry pointers pointing to a location in memory for storage of a packet.

21. The communication system of claim 14, wherein said global free queue contains a list of buffer state entry pointers each of said buffer state entry pointers pointing to a location in memory for storage of a portion of a packet of data.

22. A multi-chip communication system; comprising:
first and second memories for storing data;
a first chip, comprising:
(A) a first functional block for receiving data,
(B) a resource allocation queue, containing pointers to locations for storage of data in said first memory; wherein said pointers contain a ownership tag indicating that they belong to said first resource allocation queue;
a second chip, comprising
(C) a second functional block for transmitting data,
(D) a resource allocation queue, containing pointers to locations for storage of data in said second memory; wherein said pointers contain a ownership tag indicating that they belong to said second resource allocation queue;
wherein said second resource allocation queues returns pointers received from the other resource allocation queue, in the event data received by said first functional block and stored in said first memory, is eventually transferred to said second functional block for transmission by said second chip.
